(19) United States
(12) Patent Application Publication
(10) Pub. No.: US 2008/0307836 A1
(43) Pub. Date: Dec. 18, 2008

(54) DOOR HANDLE MODULE AND DOOR LOCK USING THE SAME

(75) Inventors: Hoduk Kim, Daegu (KR); Soohyun Kim, Daegu (KR); Duckwon Kang, Daegu (KR)

Correspondence Address: CANTOR COLBURN, LLP, 20 Church Street, 22nd Floor, Hartford, CT, 06103, US

(73) Assignee: HYUNDAE METAL CO., LTD., Daegu (KR)

(21) Appl. No.: 12/139,133

(22) Filed: Jun. 13, 2008

(30) Foreign Application Priority Data
Jun. 14, 2007 (KR) 10-2007-0058435
Apr. 25, 2008 (KR) 10-2008-0039029

(51) Int. Cl. E05B 13/10; E05B 1/00

(52) U.S. Cl. 70/91; 292/336.3

(57) ABSTRACT

A door handle module and a door lock using the same are disclosed. The door handle module according to the present invention is provided with a hollow rotating piece, a torsion spring enclosing an outer circumference of the rotating piece and being engaged with the locking protrusion formed in the mounting recess by both ends thereof, and a hollow operating piece being fixed to the outside of the rotating piece and includes a shoulder edge formed on a circumference thereof to mount the both ends of the torsion spring and an operational edge formed on an inner circumference thereof to be connected to the handle. Accordingly, the handle that has been turned to open the door can be turned back by a recovery force of the torsion spring so as to be able to maintain its neutral position, and the structure of the door handle module and the door lock can be simplified.

### BACKGROUND OF THE INVENTION

1. Field of the Invention

The present invention relates to a door handle module equipped with a neutralizing structure and a door lock using the same, and more particularly to a door handle module structured to maintain a neutral position of a door handle, turned to the left or the right to release a closed state, by using a recovery force of a torsion spring and improved in simplicity and durability of the structure thereof, and a door lock using the same.

2. Description of the Related Art

In general, a door handle module that controls opening and closing of a door, being mounted at the inside and the outside of the door, is equipped with a structure for maintaining a neutral position of the door handle by turning the door handle, which has been turned forward by an external force such as a user's operation, backward upon removal of the external force.

Conventionally, such a structure has generally been operated by a recovery force of a coil spring. However, in case of a lever-type door handle, since an eccentric load of the door handle is compressively operated onto the coil spring all the time, elasticity of the coil spring is weakened after a longtime use. Also, wearing of respective operational parts working in contact with one another would deteriorate the neutralizing function of the door handle.

If the door handle is drooped for such a reason and can hardly maintain the neutral position, the door may be easily opened although not intended so because the handle can be turned by just a minor force such as slight contact with a human body.

### SUMMARY OF THE INVENTION

Therefore, the present invention has been made in view of the above problems, and it is an object of the present invention to provide a door handle module capable of maintaining a neutral position of a door handle all the time while preventing deformation of component parts thereof caused by repetitive use.

It is another object of the present invention to provide a door handle module capable of simplifying a structure for maintaining the neutral position of the door handle, and improving productivity and assemblability thereof.

It is a further object of the present invention to provide a door lock including the handle module and having a simplified structure thereof.

In accordance with an aspect of the present invention, the above and other objects can be accomplished by the provision of a door handle module comprising a fixing plate including an entry hole formed in the center; a cover plate including an entry hole formed in the center in fluid communication with the entry hole of the fixing plate and covering an outside of the fixing plate; and a handle sequentially penetrating the entry holes of the cover plate and the fixing plate and being connected to an operational edge of a door lock assembly mounted to a door, wherein the fixing plate further includes a mounting recess having an annular form formed at an outside thereof to enclose an outer circumference of the entry hole, the mounting recess includes a locking protrusion formed on a circumference thereof. The mounting recess of the fixing plate is mounted with an elastic recovering member comprising a hollow rotating piece, a torsion spring enclosing an outer circumference of the rotating piece and being engaged with the locking protrusion formed in the mounting recess by both ends thereof, and a hollow operating piece being fixed to the outside of the rotating piece and includes a shoulder edge formed on a circumference thereof to mount the both ends of the torsion spring and an operational edge formed on an inner circumference thereof to be connected to the handle, such that the handle turned by an external force in a forward direction is able to return in a backward direction upon removal of the external force and thereby maintain a neutral position.

Here, a plurality of connection protrusions may be formed on the outer circumference of the rotating piece whereas connection recesses for fixing the connection protrusions are correspondingly formed on an inner circumference of the operating piece, such that the rotating piece, the operating piece and the torsion spring can be modularized through engagement between the connection protrusions and the connection recesses.

The rotating piece and the operating piece constituting the elastic recovering member may be integrated in the form of a rotating bush, thereby obtaining the effect of simplifying the structure.

When the neutral position of the handle is thus maintained by the elastic recovering member, drooping of the handle or unintentional opening of the door by a slight external force such as contact with a human body can be prevented.

In accordance with another aspect of the present invention, there is provided a door lock comprising a door lock assembly insertedly mounted to a door and equipped with rotating shafts formed on both sides to move a latch bolt in and out through a turning operation; and the door handle module according to the present invention, mounted to both sides of the door lock assembly to supply an external force to the respective rotating shafts through a handle, wherein, when the handle engaged with the operational edge of the elastic recovering member through the entry hole of the fixing plate is turned forward by the external force, the handle is turned back by the elastic recovering member, thereby maintaining the neutral position.

Preferably, a fastening pipe part in which equipped with a screw thread on an outer circumference thereof is concentrically disposed to the outer circumference of the rotating shaft, and a thickness controlling plate in which a nut pipe part having a pipe form and including a screw thread on an inner circumference thereof is integrally formed with the center thereof may be provided, such that the thickness controlling plate can be displaced by adjusting a fastened degree between the nut pipe part and the fastening pipe part according to the thickness of the door.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing the overall structure of a door handle module according to a first embodiment of the present invention;

FIG. 2 is a view showing a structure for mounting to a door the door handle module according to the first embodiment of the present invention;

FIG. 3 is a perspective view of an elastic recovering member, formed as a module, of the door handle module according to the first embodiment of the present invention;

FIG. 4 is a sectional structural view of the door handle module according to the first embodiment of the present invention;

FIG. 5 is a view showing an operating state of the door handle module according to the first embodiment of the present invention equipped with a neutralizing structure for a door handle;

FIG. 6 is an exploded perspective view showing the overall structure of a door handle module according to a second embodiment of the present invention;

FIG. 7 is a perspective view showing an elastic recovering member of the door handle module according to the second embodiment of the present invention;

FIG. 8 is an exploded perspective view showing a connection structure of the elastic recovering member with respect to the door handle module according to the second embodiment;

FIG. 9 is a view showing an assembled state of a door lock applying the door handle module according to the second embodiment;

FIG. 10 is a view showing a connection structure between a door lock assembly and a thickness controlling plate of the door lock shown in FIG. 9; and

FIG. 11 is a sectional view showing the door lock of FIG. 9 mounted to the door.

### DETAILED DESCRIPTION OF THE PREFERRED EMBODIMENTS

Hereinafter, exemplary embodiments of the present invention will be described in detail with reference to the accompanying drawings.

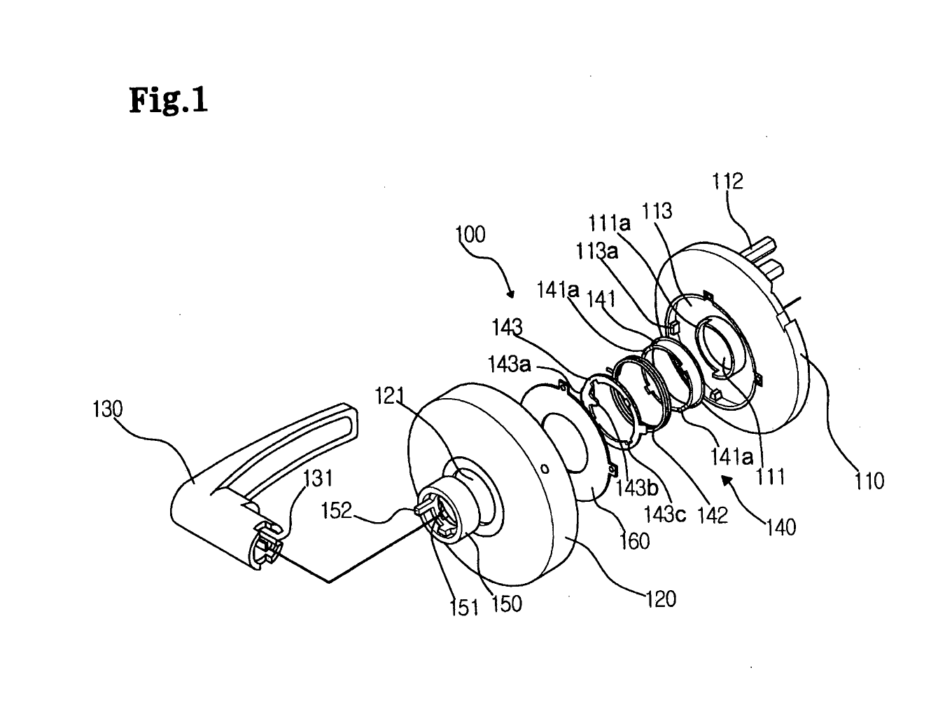

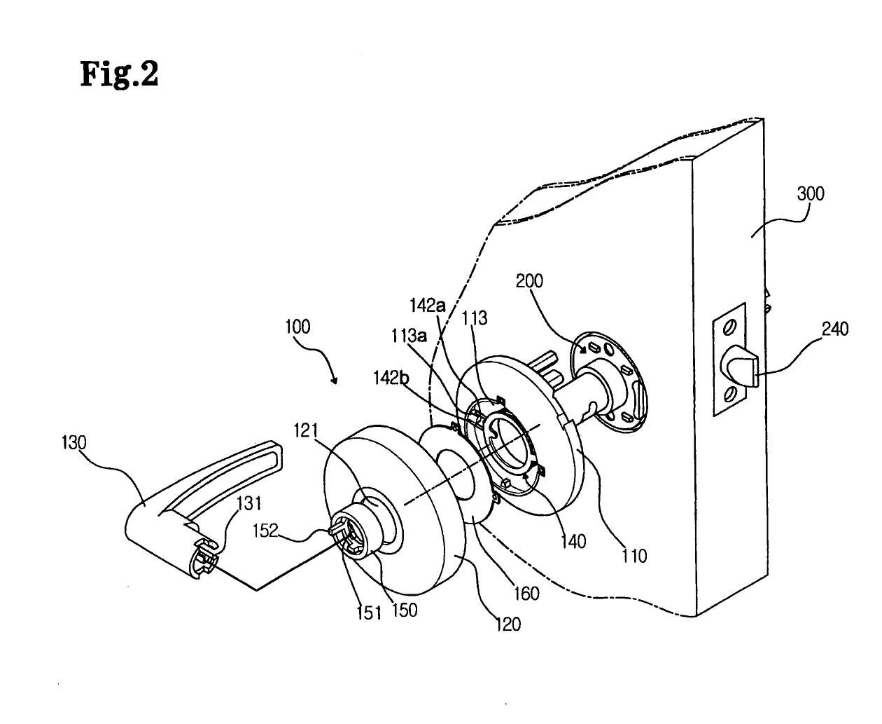

Referring to FIGS. 1 and 2, a door handle module 100 according to a first embodiment of the present invention comprises a fixing plate 110 having an entry hole 111 formed in the center and a plurality of fixing pins 112 protruded on an inner surface thereof, a cover plate 120 having another entry hole 121 fluidly communicated with the entry hole 111 of the fixing plate 110 and covering an outside of the fixing plate 110, and a handle 130 sequentially penetrating the entry holes 121 and 111 of the cover plate 120 and the fixing plate 110 to be connected with a door lock assembly 200 mounted to a door.

The door handle module 100 is mounted to the outside or the inside of the door as shown in FIG. 2 so that the door 300 can be opened using the handle 130. More specifically, as a user holds and turns the handle 130, a latch bolt 240 of the door lock assembly 200 retreats, thereby letting the door 300 open.

An elastic recovering member 140 is mounted between the fixing plate 110 and the handle 130. Therefore, the handle 130 that has been turned by an external force can be turned back by an elastic recovery force to stably maintain its neutral position.

The elastic recovering member 140 is mounted on a mounting recess 113 formed at an outer surface of the fixing plate 110. The mounting recess 113 has an annular form enclosing a circumference of the entry hole 111 disposed in the center of the fixing plate 110. In addition, a locking protrusion 113a is formed on an inner circumferential surface of the mounting recess 113.

The elastic recovering member 140 comprises a rotating piece 141 having a hollow form, a torsion spring 142 enclosing an outer circumference of the rotating piece 141, and an operating piece 143 having a hollow form and being fixed to the outside of the rotating piece 31. The elastic recovering member 140 is mounted to the mounting recess 113 by the one end 142a and the other end 142b of the torsion spring 142 being engaged with the locking protrusion 113a formed at the mounting recess 113. Additionally, in the operating piece 143, a shoulder edge 143a, on which both ends 142a and 142b of the torsion spring 142 are mounted, is protruded from an outer circumference and an operational edge 143b for engagement with the handle 130 is protruded inwardly on an inner circumference.

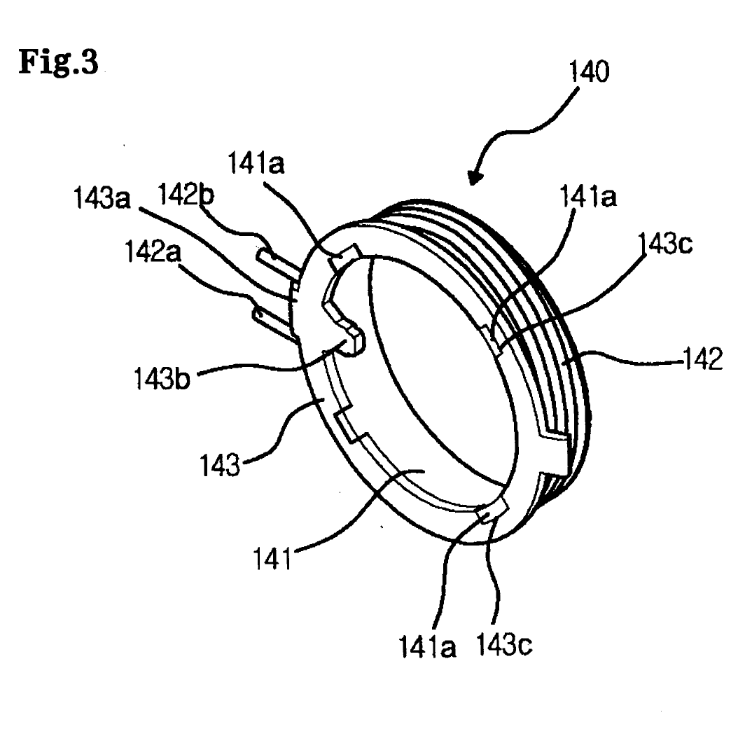

The rotating piece 141 secures a predetermined space for mounting of the torsion spring 142 by having the hollow pipe form in its structure. The operating piece 143 fixed to the outside of the rotating piece 141 is in the form of a flat board having a hole in the center. A plurality of connection protrusions 141a are formed on the outer circumference of the rotating piece 141 whereas connection recesses 143c for fixing the connection protrusions 141a are correspondingly formed on an inner circumference of the operating piece 143. Through engagement between the connection protrusions 141a and the connection recesses 143c, the rotating piece 141, the operating piece 143 and the torsion spring 142 can be modularized as shown in FIG. 3.

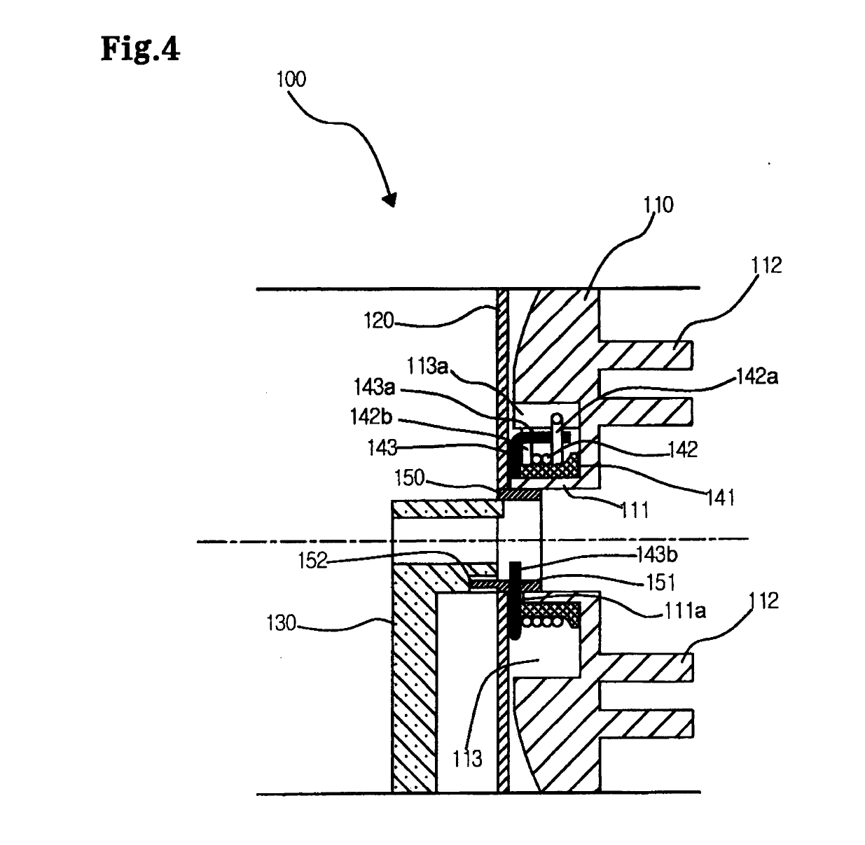

As shown in FIG. 1 or FIG. 4, the entry hole 111 of the fixing plate 110 has a hollow pipe form, and a sectional cut part 111a is formed as partially cut on an outer circumference of the entry hole 111 to function as a switching section of the operational edge 143b of the operating piece 143. Therefore, when the modularized elastic recovering member 140 is mounted to the mounting recess 113 of the fixing plate 110, the operational edge 143b of the operating piece 143 is received in the sectional cut part 111a such that turning angles of the handle 130 and the operating piece 143 are physically restricted by the sectional cut part 111a formed at the entry hole 111 having the pipe form.

According to the above structure, since the operating piece 143 which includes the operational edge 143d received in the sectional cut part 111a of the fixing plate 110, is disposed at the outermost position of the elastic recovering member 140, the elastic recovering member 140 and the fixing plate 110 can be more compactly assembled.

The one end 142a and the other end 142b of the torsion spring 142 mounted to the shoulder edge 143a of the operating piece 143 are selectively mounted to both lateral sides of the locking protrusion 113a formed on the inner circumference of the mounting recess 113. According to this, the elastic recovering member 140 that has been turned by an external force in a forward direction can be turned back in a backward direction by an elastic recovery force of the torsion spring 142, thereby maintaining a neutral position. Also, the handle 130 in engagement with the operating piece 143 of the elastic recovering member 140 can be always in the neutral position.

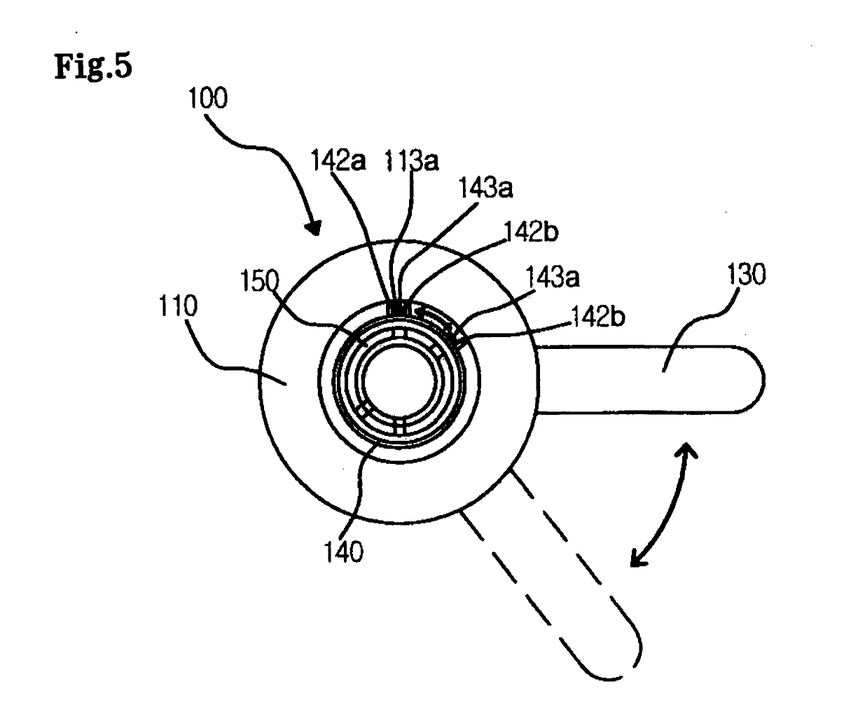

As shown in FIG. 5, in a state where the one end 142a of the torsion spring 142 is mounted on the locking protrusion 113a of the mounting recess 113, although the rotating piece 141 and the operating piece 143 are turned in the forward direction by the handle 130 with the other end 142b of the torsion spring 142 mounted thereto, the rotating piece 141 and the operating piece 143 engaged with the handle 130 can be turned back in the backward direction due to the recovery force of the torsion spring 142. Thus, the neutral position of the handle 130 can be maintained and, as a result, the door can be prevented from opening unintentionally by a minor force.

Concerning the connection structure between the handle 130 and the elastic recovering member 140, a connection bush 150 is provided to interconnect the handle 130 and the elastic recovering member 140 so as to prevent deformation of the handle 130 and the elastic recovering member 140.

The connection bush 150 has a hollow pipe form comprising a shoulder recess 151 formed on an inner end thereof and assembled with the operational edge 143a of the elastic recovering member 140, and a connection end 152 formed on an outer end thereof and assembled with a shoulder recess 131 of the handle 130. Referring to FIG. 4, the connection bush 150 is mounted to enter to the inner circumference of the mounting recess 113 of the fixing plate 110 mounted with the elastic recovering member 140 by penetrating the entry hole 121 of the cover plate 120 from the outside of the cover plate 120, thereby interconnecting the handle 130 and the elastic recovering member 140.

The handle 130 and the elastic recovering member 140 may be connected directly to each other without the medium of the connection bush 150, by forming the shoulder recess 131 of the handle 13o and the operational edge 143a of the elastic recovering member 140 to have corresponding shapes to each other. However, according to this embodiment, the handle 130 and the elastic recovering member 140 are connected through the medium of the connection bush 150 such that the connection bush 150 absorbs a shock caused from the turning operation of the handle 130 and thereby prevents deformation of the handle 130 and the elastic recovering member 140.

A reference numeral 160 denotes an auxiliary cover for preventing separation and exposure of the elastic recovering member 140 received in the mounting recess 113 of the fixing plate 110.

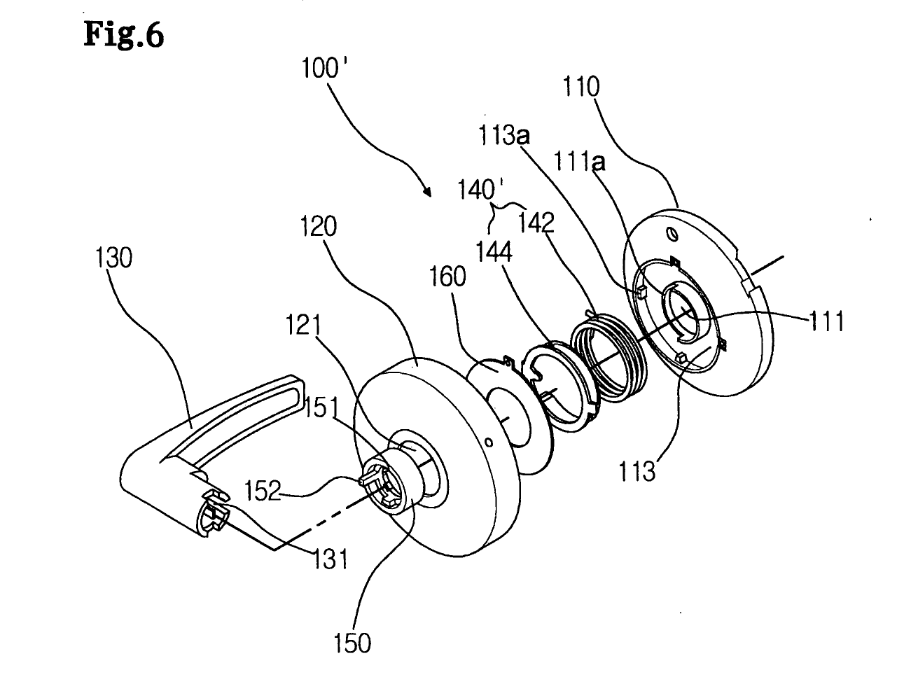

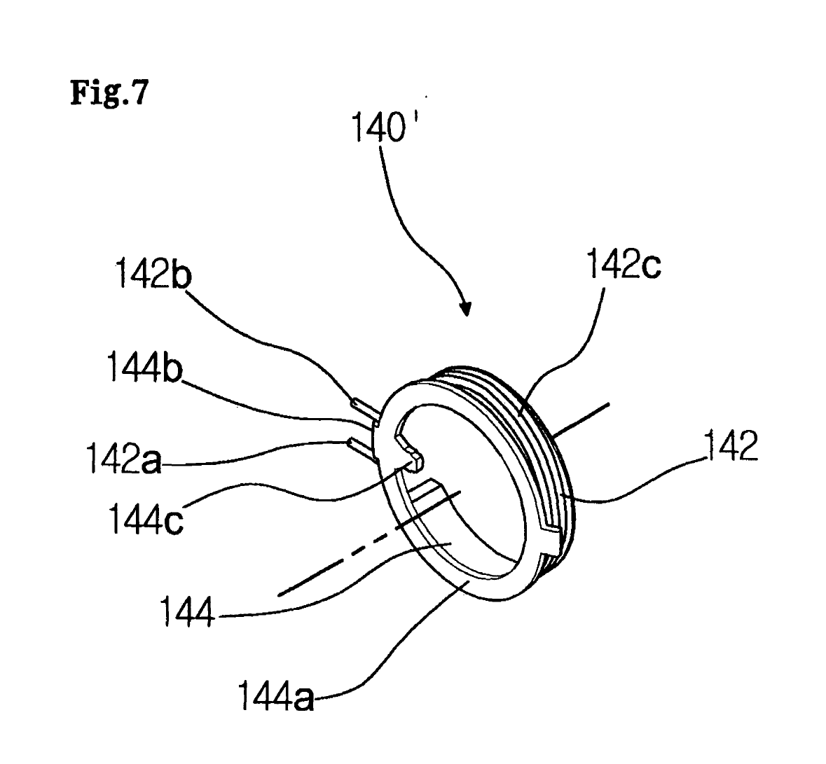

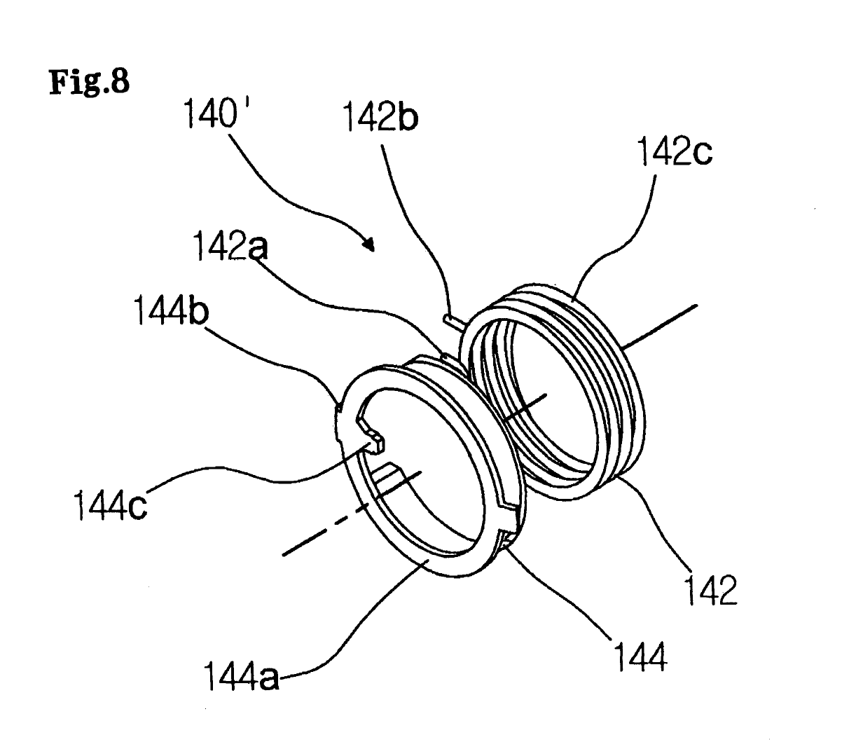

FIG. 6 through FIG. 8 show a door handle module 100′ according to a second embodiment of the present invention.

The door handle module 100′ has substantially the same structure as the door handle module 100 of the first embodiment except an elastic recovering member 140′. Therefore, the other parts but the elastic recovering member 140′ will be cited by the same reference numerals as in the first embodiment and not be explained again.

Referring to the drawings, the elastic recovering member 140′ comprises a rotating bush 144 having a hollow pipe form and a flat operating piece 144a being integrally formed in its structure, and a torsion spring 142. The operating piece 144a includes an operational edge 144c formed on an inner circumference thereof and connected to the handle 130, and shoulder edge 144b formed on a circumference thereof. In addition, the torsion spring 142 includes a winding part 142c winding the outer circumference of the rotating bush 144 and the both ends 142a and 142b which mounted to the shoulder edge 144b of the rotating bush 144.

According to the above structure, differently from in the first embodiment, the rotating piece 141 having the pipe form constituting a winding space for the torsion spring 142 and the operating piece 144a mounting thereto the ends 142a and 142b of the torsion spring 142 and being connected to the handle 130 are integrated in the form of the rotating bush 144. Therefore, the structure can be simplified.

In the second embodiment as well, when the elastic recovering member 140′ is received in the fixing plate 110, the operational edge 144c of the rotating bush 144 is received in the sectional cut part 111a of the entry hole 111 while the both ends 142a and 142b of the torsion spring 142 are mounted on both sides of the locking protrusion 113a formed at the mounting recess 113, respectively.

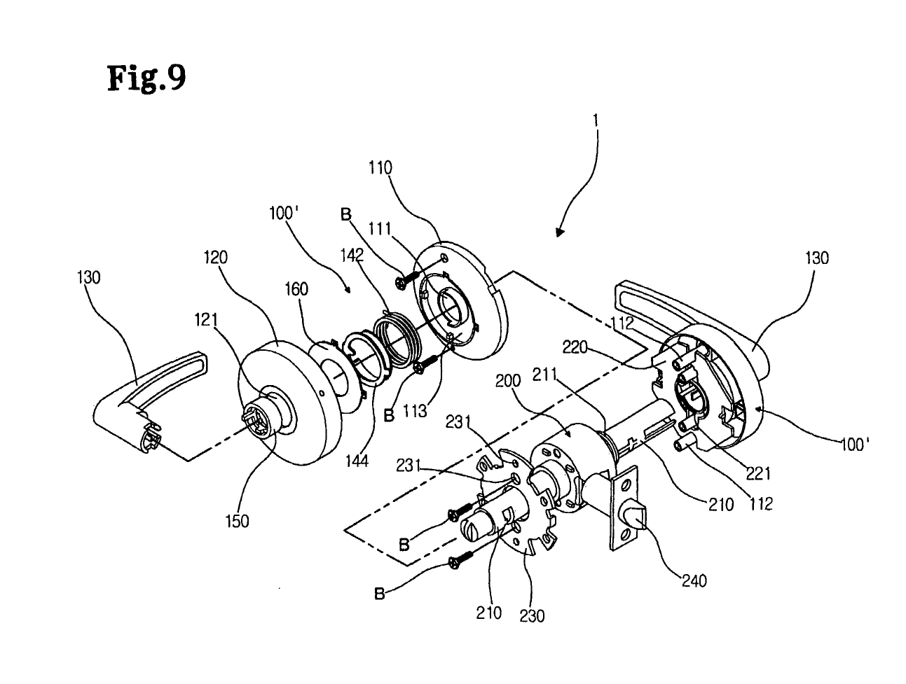

As shown in FIG. 9, a door lock applying the door handle module 100 or 100′ according to the embodiments of the present invention comprises a door lock assembly 200 insertedly mounted in the door and equipped with rotating shafts formed on both sides to move a latch bolt in and out through a turning operation, and the door handle module 100′ mounted to the both sides of the door lock assembly 200 to supply an external force to the respective rotating shafts through the handle 130. That is, in the same manner as other general door locks, the door lock applying the embodiment of the present invention is structured such that the handle 130 engaged with the operational edge of the elastic recovering member through the entry hole 111 of the fixing plate 110 is turned forward by the external force and, upon removal of the external force, turned back by the elastic recovering member, thereby maintaining the neutral position.

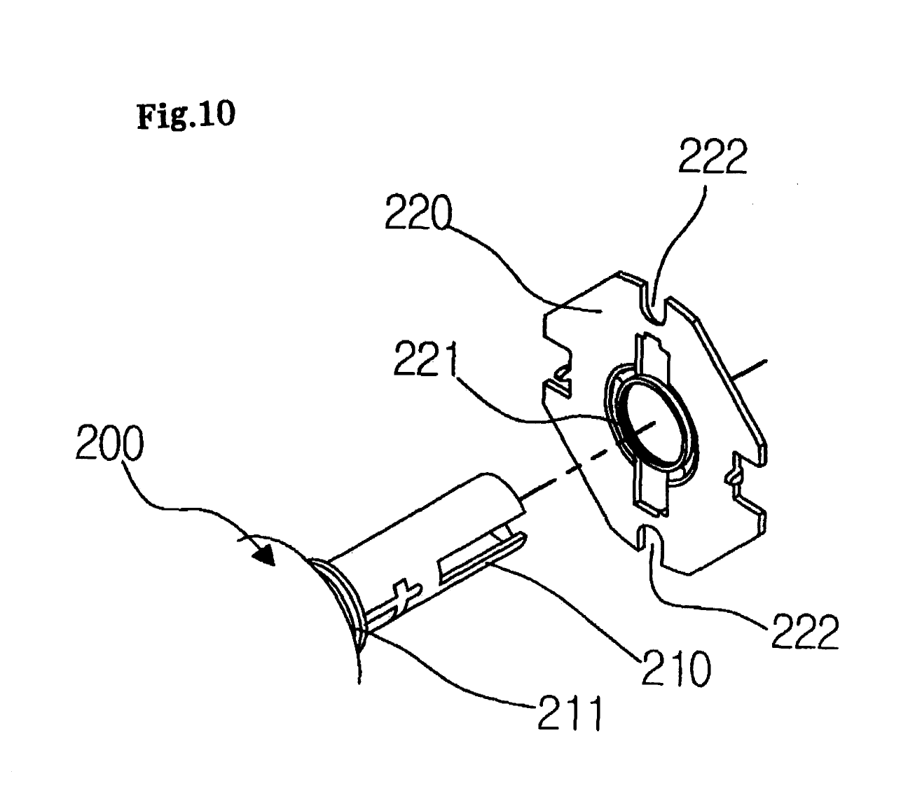

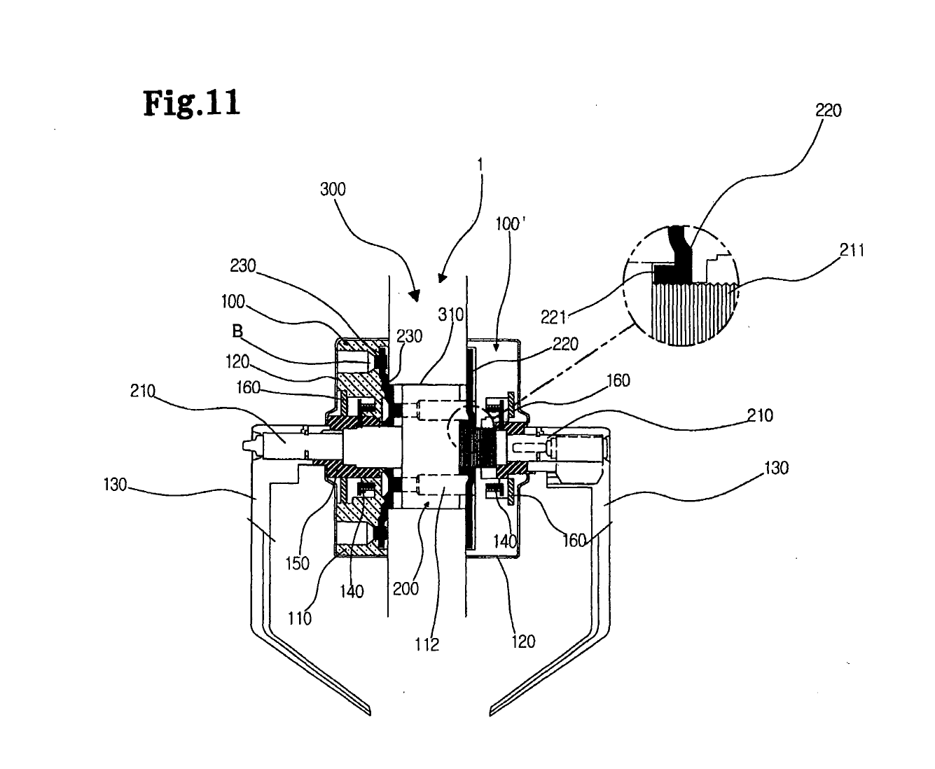

In the door lock 1 according to this embodiment as shown in FIG. 9 to FIG. 11, the door handle modules 100′ are mounted to both sides of the door lock assembly 200 which is insertedly mounted to the door such that the handles 130 of the door handle modules 100′ are directly connected to rotating shafts 210 protruded from both sides of the door lock assembly 200.

More specifically, when the door lock assembly 200 is inserted in a mounting hole 310 of the door 300 comprising the mounting hole 310 and a latch hole which is a moving path of the latch bolt, the rotating shafts 210 are protruded from the both sides of the door 300. In this state, a fastening plate 230 and a thickness controlling plate 220 are mounted to the inside and the outside of the door lock assembly 200, respectively, to fit around the rotating shafts 210.

In addition, a nut pipe part 221 in the form of a pipe including a screw thread on an inner circumference thereof is integrally mounted with the center of the thickness controlling plate 220. At an outer edge of the thickness controlling plate 220, one or more penetration holes 222 are formed to serve as penetrating paths of the fixing pins 112 formed at the door handle module 100′. Furthermore, a fastening pipe part 211 having a screw thread on an outer circumference thereof is formed to the outer circumference of the rotating shaft 210 concentrically, such that the rotating shaft 210 and the thickness controlling plate 220 can be connected to each other through the fastening pipe part 211 of the rotating shaft 210 and the nut pipe part 221 of the thickness controlling plate 220.

Through such a structure, the thickness controlling plate 220 can be displaced by adjusting a fastened degree between the nut pipe part 221 and the fastening pipe part 211 according to the thickness of the door 300 mounted with the door lock assembly 200. When the nut pipe part 221 is integrally formed with the thickness controlling plate 220, a dedicated fixing member for fixing the thickness controlling plate 220 can be omitted and consequently, the structure can be simplified.

The door handle module 100′ is mounted respectively to both sides of the door lock assembly 200. The fixing pins 112 formed on the door handle module 100′ and the fastening plate 230 mounted to the inside of the door lock assembly 200 are fastened to each other through bolts B, thereby fixing the door handle module 100′ to the door lock assembly 200. Thus, assembling of the door lock 1 is completed.

Although only the door handle module 100′ according to the second embodiment of the present invention is illustrated and explained, the door handle module 100 according to the first embodiment can also be directly applied to the door lock 1.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A door handle module comprising:
a fixing plate including an entry hole formed in the center;
a cover plate including an entry hole formed in the center in fluid communication with the entry hole of the fixing plate and covering an outside of the fixing plate;
and a handle sequentially penetrating the entry holes of the cover plate and the fixing plate and being connected to a door lock assembly mounted to a door,
wherein the fixing plate further includes a mounting recess having an annular form formed at an outside thereof to enclose an outer circumference of the entry hole, the mounting recess includes a locking protrusion formed on a circumference thereof, and
the mounting recess of the fixing plate is mounted with an elastic recovering member comprising a hollow rotating piece, a torsion spring enclosing an outer circumference of the rotating piece and being engaged with the locking protrusion formed in the mounting recess by both ends thereof, and a hollow operating piece being fixed to the outside of the rotating piece and includes a shoulder edge formed on a circumference thereof to mount the both ends of the torsion spring and an operational edge formed on an inner circumference thereof to be connected to the handle,
such that the handle turned by an external force in a forward direction is able to return in a backward direction upon removal of the external force and thereby maintain a neutral position.

2. The door handle module according to claim 1, wherein a plurality of connection protrusions are formed on the outer circumference of the rotating piece whereas connection recesses for fixing the connection protrusions are correspondingly formed on an inner circumference of the operating piece, such that the rotating piece, the operating piece and the torsion spring can be modularized through engagement between the connection protrusions and the connection recesses.

3. The door handle module according to claim 1, wherein the rotating piece and the operating piece constituting the elastic recovering member are integrated in the form of a rotating bush.

4. The door handle module according to claim 1, wherein the entry hole of the fixing plate has a pipe form, and a sectional cut part is formed as partially cut on an outer circumference of the entry hole to function as a switching section of the operational edge of the operating piece such that turning angles of the operating piece according to turning of the handle are physically restricted by the sectional cut part.

5. The door handle module according to claim 1, wherein a connection bush is formed on an inner circumference of the elastic recovering member, having a hollow pipe form comprising a shoulder recess formed on an end thereof and assembled with the operational edge of the elastic recovering member, and a connection end formed on the other end thereof and assembled with a shoulder recess of the handle, such that the connection bush prevents the handle and the elastic recovering member from being deformed due to direct connection between each other.

6. A door lock comprising:
a door lock assembly insertedly mounted to a door and equipped with rotating shafts formed on both sides to move a latch bolt in and out through a turning operation; and
the door handle module according to any one of claim 1 to claim 5, mounted to both sides of the door lock assembly to supply an external force to the respective rotating shafts through a handle,
wherein, when the handle engaged with the operational edge of the elastic recovering member through the entry hole of the fixing plate is turned forward by the external force, the handle is turned back by the elastic recovering member, thereby maintaining the neutral position.

7. The door lock according to claim 6, wherein a fastening pipe part in which equipped with a screw thread on an outer circumference thereof is concentrically disposed to the outer circumference of the rotating shaft, and a thickness controlling plate in which a nut pipe part having a pipe form and including a screw thread on an inner circumference thereof is integrally formed with the center thereof is provided, such that the thickness controlling plate can be displaced by adjusting a fastened degree between the nut pipe part and the fastening pipe part according to the thickness of the door.
